(19) United States
(12) Patent Application Publication
(10) Pub. No.: US 2016/0189236 A1
(43) Pub. Date: Jun. 30, 2016

(54) TECHNIQUES FOR REDUCING IRRELEVANT ADS

(71) Applicant: Yahoo! Inc., Sunnyvale, CA (US)

(72) Inventors: Varun Bhagwan, San Jose, CA (US); Doug Sharp, San Francisco, CA (US)

(21) Appl. No.: 14/584,082

(22) Filed: Dec. 29, 2014

(51) Int. Cl. G06Q 30/02

(52) U.S. Cl. CPC G06Q 30/0269

(57) ABSTRACT

Techniques are described for identifying advertising content that should not be shown to users. Information representing characteristics of a user, behavior of the user, and/or events in the life of that user is used to filter out or negatively bias selection of inappropriate or irrelevant ads.

### BACKGROUND

Online advertising techniques employ a variety of sophisticated algorithms to identify and present advertising content to users that will be of interest, and therefore likely to result in desired behaviors or “conversions,” e.g., navigating to a merchant's web site, purchasing a product or service, selecting a link, etc. But, as sophisticated as these algorithms are, they often result in the presentation of advertising content that has the opposite of the intended effect. For example, users are often bombarded with ads for the same product even though they have already purchased the product, or demonstrated their lack of interest by ignoring previous ads. Not only do such repetitious ads represent lost revenue (i.e., because more relevant and therefore more effective ads could have been presented), they also negatively impact user experience.

### SUMMARY

According to various implementations, methods, apparatus, systems, and computer program products are provided for reducing irrelevant ads. According to some implementations, input is received relating to interaction of a first user with a user interface of a client device. A plurality of candidate advertisements is filtered with reference to user data corresponding to the first user to eliminate one or more of the candidate advertisements resulting in one or more remaining advertisements. The user data represent one or more characteristics of the first user, one or more behaviors of the first user, or one or more events associated with the first user. A first one of the remaining advertisements is selected for presentation to the first user. The first remaining advertisement is caused to be transmitted to the client device.

According to a specific implementation, the user data for the first user are generated with reference to one or more of: a purchase by the first user, a preference expressed by the first user, online behavior of the first user, demographic information of the first user, a location of the first user, a search by the first user, an occurrence of one of the one or more events, a context associated with the first user, or a status of the first user.

According to a specific implementation, the user data are generated by extracting information from one or more of: an electronic message sent or received by the first user, first online content posted by the first user, second online content about the first user, third online content directed to the first user, an online transaction database including one or more transactions involving the first user, or online account information of the first user.

According to a specific implementation, the plurality of candidate advertisements is identified using a targeted advertising algorithm.

According to a specific implementation, the plurality of candidate advertisements includes at least one untargeted advertisement that is not selected with reference to the first user.

According to a specific implementation, the candidate advertisements are filtered by referring to correlation data representing one or more correlations between the first user or a category of users including the first user and one or more specific advertisements or advertisement categories. According to a more specific implementation, the correlation data are associated with one or both of the first user or the candidate advertisements.

According to some implementations, input is received relating to interaction of a first user with a user interface of a client device. A plurality of candidate advertisements is identified using a targeted advertising algorithm. The targeted advertising algorithm is configured to negatively bias one or more of the candidate advertisements with reference to user data corresponding to the first user to reduce the likelihood that the one or more of the candidate advertisements will be presented to the first user. The user data represent one or more characteristics of the first user, one or more behaviors of the first user, or one or more events associated with the first user. A first one of the candidate advertisements is selected for presentation to the first user. The first candidate advertisement is transmitted for presentation on the client device.

According to a specific implementation, the user data is for the first user is generated with reference to one or more of: a purchase by the first user, a preference expressed by the first user, online behavior of the first user, demographic information of the first user, a location of the first user, a search by the first user, an occurrence of one of the one or more events, a context associated with the first user, a status of the first user.

According to a specific implementation, the user data is generated by extracting information from one or more of: an electronic message sent or received by the first user, first online content posted by the first user, second online content about the first user, third online content directed to the first user, an online transaction database including one or more transactions involving the first user, or online account information of the first user.

According to a specific implementation, the candidate advertisements are identified by referring to correlation data representing one or more correlations between the first user or a category of users including the first user and one or more specific advertisements or advertisement categories. According to a more specific implementation, the correlation data are associated with one or both of the first user or the candidate advertisements.

A further understanding of the nature and advantages of various implementations may be realized by reference to the remaining portions of the specification and the drawings.

### BRIEF DESCRIPTION OF THE DRAWINGS

FIG. 1 shows a network environment in which various implementations may be practiced.

FIG. 2 is a flowchart illustrating operation of a particular implementation.

FIG. 3 is a flowchart illustrating operation of another implementation.

### DETAILED DESCRIPTION

Reference will now be made in detail to specific implementations. Examples of these implementations are illustrated in the accompanying drawings. It should be noted that these examples are described for illustrative purposes and are not intended to limit the scope of this disclosure. Rather, alternatives, modifications, and equivalents of the described implementations are included within the scope of this disclosure as defined by the appended claims. In addition, specific details may be provided in order to promote a thorough understanding of the described implementations. Some implementations within the scope of this disclosure may be practiced without some or all of these details. Further, well known features may not have been described in detail for the sake of clarity.

This disclosure describes techniques for identifying advertisements or advertising content that should not be shown to users. The disclosed techniques may be integrated or used in conjunction with any of a variety of targeted advertising algorithms that are intended to identify relevant advertising content for specific users. Some implementations may be used to prevent the presentation of untargeted advertisements as well. Information representing characteristics of a user, behavior of the user, and/or events in the life of that user is associated with the user (e.g., as metadata, as part of a user profile, etc.). This information is used to filter out advertisements or to negatively bias selection of advertisements by a targeted advertising algorithm. That is, advertising content or advertisements (also referred to as “ads”) that are deemed to be in conflict with the information associated with the user are either eliminated or ranked so low they are unlikely to be presented to the user, thus resulting in the reduction or elimination of ads that, using conventional approaches, would have otherwise been considered relevant to that user. Not only does this result in a reduction in the presentation of irrelevant ads to users, it also has the potential to increase advertising revenue in that the proportion of ads that lead to conversion events (e.g., clicks, purchases, etc.) is likely to increase. Some examples will be illustrative.

If a user recently purchased a smart phone, it would not make sense to continue to present ads for smart phones to that user; either for the same brand/model or for different brands/models. The user is simply unlikely to consider such ads relevant; at least for a period of time. Similarly, if a user was recently married, it would not be appropriate to present ads for matchmaking or dating sites to that user. In another example, it might be upsetting for a user to be presented with ads for mortgages if that user recently suffered a foreclosure on her home. Unfortunately, such inappropriate ad selections are typical of conventional targeted advertising techniques. By contrast, the techniques enabled by the present disclosure use information about the user to reduce or eliminate the presentation of irrelevant ads; preferably in favor of more relevant ones.

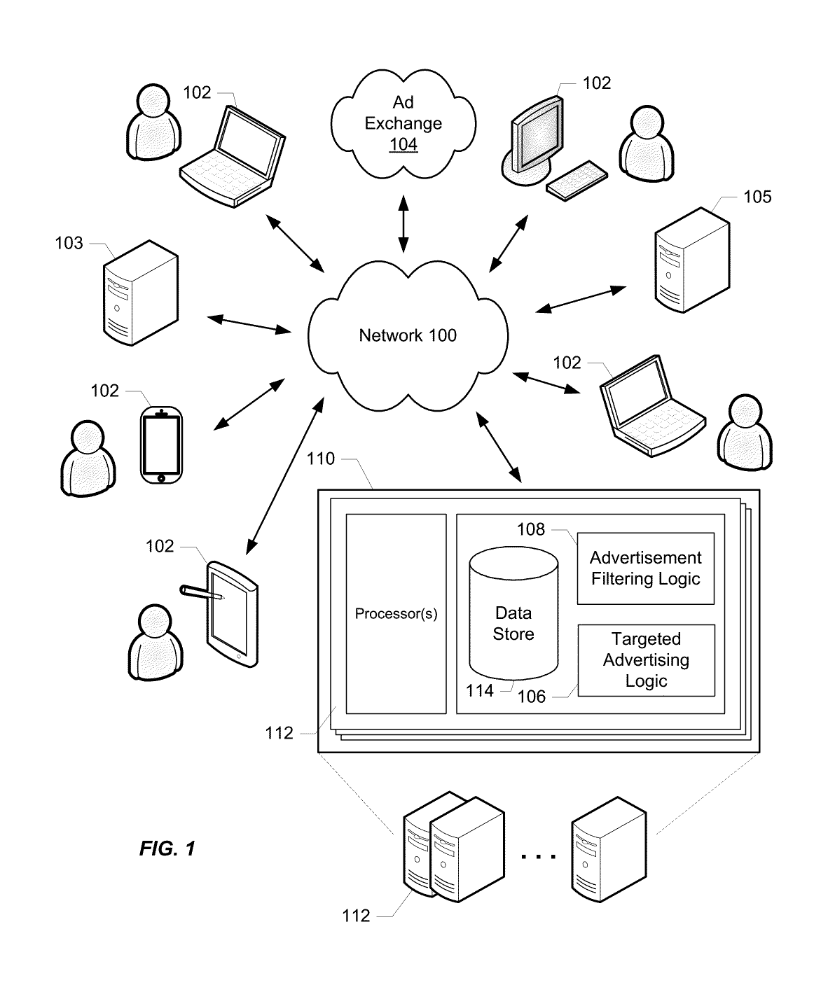

FIG. 1 shows a network environment in which the techniques enabled by this disclosure may be implemented. The depicted network 100 may include any subset or combination of a wide variety of network environments including, for example, TCP/IP-based networks, telecommunications networks, wireless networks, cable networks, public networks, private networks, wide area networks, local area networks, the Internet, the World Wide Web, intranets, extranets, etc. Client devices 102 may be any device capable of connecting to network 100 and interacting with the great diversity of sites, networks, and systems (not shown) interconnected by or integrated with network 100 in ways that result in the presentation of advertisements on client devices 102. Such devices include, but are not limited to, mobile devices (e.g., cell phones, smart phones, smart watches, tablets, etc.), personal computers (e.g., laptops and desktops), set top boxes (e.g., for cable and satellite systems), smart televisions, and gaming systems.

Advertisements presented on client devices 102 may be selected and presented in a wide variety of ways. For example, ads might be selected and presented by means of an advertising exchange 104, i.e., an online marketplace in which connections are made between the inventory of online publishers (e.g., advertising space on web page) and the inventory of advertisers (e.g., advertisements or advertising content). Advertisers pay according to a variety of economic models for events (e.g., ad impressions, users clicking on ads, conversion events, etc.) relating to the placement of their advertisements. Third parties (e.g., brokers, agents, agencies, consortiums, networks, etc.) might also participate in the exchange, making connections between publishers and advertisers and, in some cases, representing and managing the advertising campaigns of multiple entities in the exchange. Alternatively, some entities (represented by publisher server 103 and advertiser server 105) might establish direct relationships and deals with their advertising partners. It should be noted that, regardless of how an advertisement makes its way to a client device, it may be selected in accordance with the techniques enabled by the present disclosure.

For the sake of clarity and simplicity, FIG. 1 and the following description assume an implementation in which the selection and/or filtering of ads as enabled by this disclosure (represented by targeted advertising logic 106 and/or advertisement filtering logic 108) are implemented as part of a platform 110 that also transmits ads to client devices 102 for presentation. As will be understood, platform 110 may conform to any of a wide variety of architectures such as, for example, a distributed platform deployed at one or more co-locations, each implemented with one or more servers 112. Data store 114 is also shown as part of platform 110 and may include, among other things, advertising content as well as the user data used to filter or negatively bias selection of ads. However, it should be noted that implementations are contemplated in which one or more of these functions or data sets operate or are stored remotely from the others (e.g., on other platforms such as 103, 104, or 105), and/or are under the control of one or more independent entities (e.g., publishers, advertisers, third parties in and out of an ad exchange, etc.).

It should also be noted that, despite references to particular computing paradigms and software tools herein, the logic and/or computer program instructions on which various implementations are based may correspond to any of a wide variety of programming languages, software tools and data formats, may be stored in any type of non-transitory computer-readable storage media or memory device(s), and may be executed according to a variety of computing models including, for example, a client/server model, a peer-to-peer model, on a stand-alone computing device, or according to a distributed computing model in which various functionalities may be effected or employed at different locations. In addition, any references to particular protocols herein are merely by way of example. Suitable alternatives known to those of skill in the art for all of these variations may be employed.

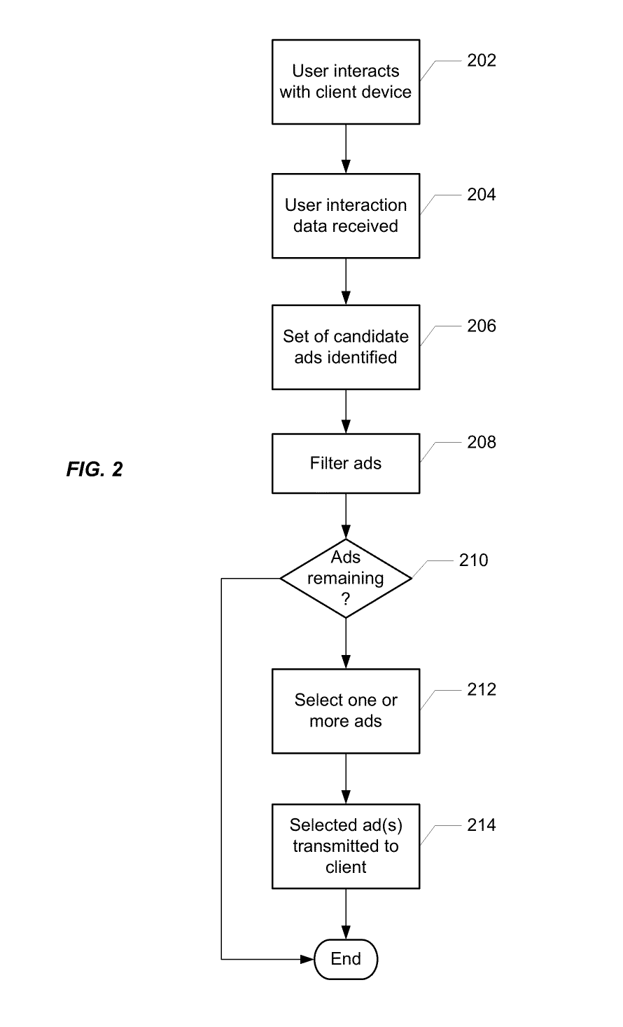

An example of the operation of advertising filtering logic according to a particular implementation will now be described with reference to the flowchart of FIG. 2. When a user interacts with a user interface associated with a client device (202), data representing that interaction are received at a remote platform (204). As will be appreciated, the nature of the client device, the user interface, the interaction, the data, and the remote platform may vary considerably. For example, the user might be entering a search query in a search engine using his laptop. In another example, the user might be launching an app on her mobile device. In yet another example, the user might be selecting content with his smart TV or his gaming system. The data that represent the interaction would be in a format that is appropriate for the given use case and may be received by a variety of remote platforms (e.g., a search engine, an app service provider, a content provider, etc.). Those of skill in the art will appreciate the range of possible use cases with reference to the diversity of these examples.

Regardless of the specific use case, the user's interaction with the user interface represents an opportunity to present advertising content (e.g., in the form of one or more ads) to the user via the user interface (e.g., as a sponsored search result, a banner add, a video, etc.). Thus, in response to the data representing the interaction, a set of candidate ads is identified for presentation to the user (206). The set of candidate ads may be identified in a variety of ways. For example, the candidate ads might be identified using any of a wide variety of targeted advertising algorithms. Alternatively, the ads might be identified or selected in ways that do not target the specific user, e.g., with reference to particular content or a particular service being consumed. More generally, candidate ads may be identified with varying levels of targeting; from highly-specific user targeting to random selection.

The set of candidate ads is then filtered to remove any ads that are considered to be in conflict with user data that represents one or more characteristics of the user, one or more behaviors of the user, and/or one or more events associated with the user (208). If there are any ads remaining (210), one or more are selected (212) and transmitted to the client device (214) for presentation to the user.

The user data that are used to filter the ads may be generated or accumulated for the user in a wide variety of ways. For example, the user data might be included in a user profile that is maintained for the user by any of a wide variety of platforms or entities, e.g., in connection with an online account, membership in an online community, specifically for use as input to a targeted advertising algorithm, etc. Alternatively, the user data might be maintained separately from such user profiles, e.g., specifically for use in filtering ads identified by other platforms. The user data might be aggregated with data for multiple users, e.g., by putting specific users or categories of users on “black lists” for specific ads or categories of ads. The user data might be partially or entirely generated in real time, i.e., substantially contemporaneous with the advertising opportunity, such as, for example, in conjunction with the user responding to a survey or filling out a form.

The user data may include any of a wide variety of information representing characteristics of the user, behaviors of the user, and/or events associated with the user, e.g., the identity of the user, preferences expressed by the user, online behavior of the user, demographic information of the user, location associated with the user, purchases by the user, searches conducted by the user, the occurrence of one or more events in the life of the user, a context associated with the user, a status of the user, etc. For example, a user might indicate preferences by indicating that is a fan of an artist or an author, or by “liking” something in the context of an online community or social network. A user might change his status from “single” to “married” in a social network. A user might search for and purchase products and services. A user might frequent certain online sites or real-world geographic locations. The user data might represent or include an affirmative expression of a characteristic, behavior, or event. Alternatively, the user data might include indicators or flags that operate or are interpreted as prohibitions against particular ads or categories of ads (e.g., an ad “black list” associated with the user). As will be appreciated, the range of possibilities for user data that may be used as described herein is considerable.

The ways in which the user data can be acquired or generated are also quite diverse. For example, user data can be generated or acquired by extracting or deriving information from an electronic message sent or received by the user, online content posted by, about, or directed to the user, a transaction database including transactions involving the user, online account information of the user, search logs including searches conducted by the user, etc. For example, a user might send an email or post content indicating that she recently was engaged to be married. A user might receive a receipt for a recent purchase by email. An online merchant or service provider might maintain a database tracking purchases of its users. Again, the range of possibilities is considerable.

Instead of (or in addition to) using information about a user to identify ads or categories of ads to show the user, the techniques described herein use such information to identify ads or categories of ads NOT to show that user. As alluded to above, such an approach can even be used to filter untargeted ads, i.e., ads that are not selected with reference to the user. Thus, a recently married user would not be shown ads for an online dating service. A user who recently purchased a luxury car would not be shown ads for automobile sales.

And as discussed above, one approach contemplated by one class of implementations is to generate a set of candidate ads (e.g., using a targeting algorithm) and then, based on some characteristic of or event associated with the user, filter or eliminate ads from the set that would be irrelevant or unwelcome. This approach can be advantageous where ad selection and placement involves multiple parties and platforms and where the publisher (e.g., web site operator) doesn't have control over the ads that are being selected.

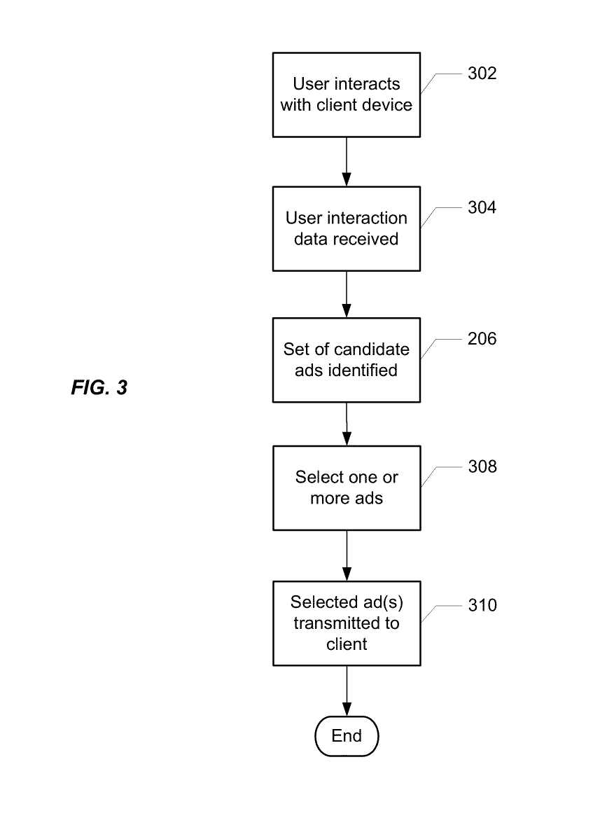

According to another class of implementations, a targeted advertising algorithm can be configured in accordance with the techniques described herein to negatively bias candidate advertisements using the user data to reduce the likelihood that irrelevant or unwelcome advertisements will be presented to the user. Such an approach might be more suitable where, for example, ad selection and placement involves relatively fewer parties or platforms acting in closer cooperation than more distributed approaches. The flowchart of FIG. 3 illustrates such an implementation.

As with the implementation described above with reference to FIG. 2, when a user interacts with a user interface associated with a client device (302), data representing that interaction are received at a remote platform (304). A set of candidate advertisements is identified using a targeted advertising algorithm that is configured to negatively bias the candidate advertisements with reference to user data to reduce the likelihood that one or more of the candidate advertisements will be presented to the user (306). As discussed above, the user data may represent one or more characteristics of the user, one or more behaviors of the user, and/or one or more events associated with the user. One or more of the candidate ads are selected (308) and transmitted to the client device (310) for presentation to the user.

The way in which a negative bias may be introduced in a targeted advertising algorithm may vary considerably without departing from the scope of this disclosure. For example, ads that correspond to particular characteristics, behaviors, and/or events of the user may have a factor applied to or a component included in their rankings to ensure that they are ranked sufficiently low that they are unlikely to be presented. In another example, post-selection filtering based on such user data may be integrated into the algorithm. Other ways to introduce such negative biases may depend on the nature of the targeting algorithm and will be apparent to those of skill in the art.

Depending on the particular implementation, the correlation between a user or category of user and an ad or category of ads that should not be shown to that user or category of users can be made at different times without departing from the scope of this disclosure. For example, the correlation might be identified substantially contemporaneously with the advertising opportunity, e.g., ads that should not be shown to a particular user can be identified and filtered (or negatively biased for selection) in conjunction with or around the same time as the selection and presentation of an ad to the user. Alternatively, the correlation may be made at some time prior to the advertising opportunity. For example, a user or category of users might be placed on a black list for an ad or a category of ads with that correlation then being subsequently used to filter ads or negatively bias ads for selection. In another example, particular ads or categories of ads that should not be shown to a user can be associated with the user (e.g., in the user's profile) for subsequent use. Combinations and variations of these will be appreciated by those of skill in the art.

A variety of types of information associated with the ads can be used for determining whether the ads should be shown to particular users or user types. For example, such information can be any of the conventional metadata that are typically associated with ads. Alternatively, additional information and tags might be inserted in or associated with ads for this specific purpose. In either case, such information might identify, for example, the ad category or subject matter (which might be derived, for example, from ad booking information). Such information can also be determined dynamically from the content of the ad itself, e.g., by extracting text or images from the ad content. The information associated with an ad might also (or alternatively) identify the characteristics, behaviors, events, etc., of users to whom the ad should not be shown. Combinations and variations of these will be appreciated by those of skill in the art.

The techniques described herein contemplate a variety of mechanisms by which correlations between users or categories of users and ads or categories of ads which should not be shown to those users may be determined. For example, a wide variety of common sense correlations can be manually introduced by human coders (e.g., recent purchasers of a product should not be shown ads for that product or product type). In addition or as an alternative to this, more systematic approaches might be employed. For example, consumer survey data can be mined to identify such correlations. In another example, user feedback (e.g., complaints) relating to specific ads can be mined to identify such correlations.

According to some implementations, machine learning techniques may be employed to identify ads or categories of ads that should not be shown to particular users or categories of users. For example, such algorithms can correlate information about users and the propensity to click on particular ads. User characteristics (behavior, events, etc.) that correlate with a low propensity to click on certain types of ads can result in such users being identified as not to be shown those types of ads (or, conversely, those ads as not to be shown to those types of users). As will be appreciated with reference to these and other implementations described herein, not only will the techniques enabled herein result in more relevant ads being presented to some users, ad inventory deemed not relevant for one segment of users may be saved for presentation to other segments of users that represent a greater likelihood of some kind of conversion.

It will be understood by those skilled in the art that changes in the form and details of the implementations described herein may be made without departing from the scope of this disclosure. For example, implementations have been described above in which ads, users, or both are tagged in some way to facilitate ad selection and/or filtering. However, it should be understood that implementations are contemplated in which neither ads nor users need to be specially tagged. For example, by learning the relevant correlations and integrating them with ad selection and/or filtering logic, ad selection can be biased in a way that results in certain types of ads not being shown to certain types of users regardless of whether the ads or the users were previously identified or tagged specifically for this purpose.

In addition, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A computer-implemented method, comprising:
receiving input relating to interaction of a first user with a user interface of a client device;
filtering a plurality of candidate advertisements with reference to user data corresponding to the first user to eliminate one or more of the candidate advertisements resulting in one or more remaining advertisements, the user data representing one or more characteristics of the first user, one or more behaviors of the first user, or one or more events associated with the first user;
selecting a first one of the remaining advertisements for presentation to the first user; and
causing the first remaining advertisement to be transmitted to the client device.

2. The method of claim 1, further comprising generating the user data for the first user with reference to one or more of: a purchase by the first user, a preference expressed by the first user, online behavior of the first user, demographic information of the first user, a location of the first user, a search by the first user, an occurrence of one of the one or more events, a context associated with the first user, or a status of the first user.

3. The method of claim 1, further comprising generating the user data by extracting information from one or more of: an electronic message sent or received by the first user, first online content posted by the first user, second online content about the first user, third online content directed to the first user, an online transaction database including one or more transactions involving the first user, or online account information of the first user.

4. The method of claim 1, further comprising identifying the plurality of candidate advertisements using a targeted advertising algorithm.

5. The method of claim 1, wherein the plurality of candidate advertisements includes at least one untargeted advertisement that is not selected with reference to the first user.

6. The method of claim 1, wherein filtering the candidate advertisements includes referring to correlation data representing one or more correlations between the first user or a category of users including the first user and one or more specific advertisements or advertisement categories.

7. The method of claim 6, wherein the correlation data are associated with one or both of the first user or the candidate advertisements.

8. A system, comprising one or more computing devices configured to:
receive input relating to interaction of a first user with a user interface of a client device;
filter a plurality of candidate advertisements with reference to user data corresponding to the first user to eliminate one or more of the candidate advertisements resulting in one or more remaining advertisements, the user data representing one or more characteristics of the first user, one or more behaviors of the first user, or one or more events associated with the first user;
select a first one of the remaining advertisements for presentation to the first user; and
cause the first remaining advertisement to be transmitted to the client device.

9. The system of claim 8, wherein the one or more computing devices are further configured to generate the user data for the first user with reference to one or more of: a purchase by the first user, a preference expressed by the first user, online behavior of the first user, demographic information of the first user, a location of the first user, a search by the first user, an occurrence of one of the one or more events, a context associated with the first user, or a status of the first user.

10. The system of claim 8, wherein the one or more computing devices are further configured to generate the user data by extracting information from one or more of: an electronic message sent or received by the first user, first online content posted by the first user, second online content about the first user, third online content directed to the first user, an online transaction database including one or more transactions involving the first user, or online account information of the first user.

11. The system of claim 8, wherein the one or more computing devices are further configured to identify the plurality of candidate advertisements using a targeted advertising algorithm.

12. The system of claim 8, wherein the plurality of candidate advertisements includes at least one untargeted advertisement that is not selected with reference to the first user.

13. The system of claim 8, wherein the one or more computing devices are configured to filter the candidate advertisements with reference to correlation data representing one or more correlations between the first user or a category of users including the first user and one or more specific advertisements or advertisement categories.

14. The system of claim 13, wherein the correlation data are associated with one or both of the first user or the candidate advertisements.

15. A computer-implemented method, comprising:
receiving input relating to interaction of a first user with a user interface of a client device;
identifying a plurality of candidate advertisements using a targeted advertising algorithm, the targeted advertising algorithm being configured to negatively bias one or more of the candidate advertisements with reference to user data corresponding to the first user to reduce the likelihood that the one or more of the candidate advertisements will be presented to the first user, the user data representing one or more characteristics of the first user, one or more behaviors of the first user, or one or more events associated with the first user;
selecting a first one of the candidate advertisements for presentation to the first user; and
transmitting the first candidate advertisement for presentation on the client device.

16. The method of claim 1, further comprising generating the user data for the first user with reference to one or more of: a purchase by the first user, a preference expressed by the first user, online behavior of the first user, demographic information of the first user, a location of the first user, a search by the first user, an occurrence of one of the one or more events, a context associated with the first user, a status of the first user.

17. The method of claim 1, further comprising generating the user data by extracting information from one or more of: an electronic message sent or received by the first user, first online content posted by the first user, second online content about the first user, third online content directed to the first user, an online transaction database including one or more transactions involving the first user, or online account information of the first user.

18. The method of claim 1, wherein identifying the candidate advertisements includes referring to correlation data representing one or more correlations between the first user or a category of users including the first user and one or more specific advertisements or advertisement categories.

19. The method of claim 18, wherein the correlation data are associated with one or both of the first user or the candidate advertisements.

20. A system, comprising one or more computing devices configured to:
receive input relating to interaction of a first user with a user interface of a client device;
identify a plurality of candidate advertisements using a targeted advertising algorithm, the targeted advertising algorithm being configured to negatively bias one or more of the candidate advertisements with reference to user data corresponding to the first user to reduce the likelihood that the one or more of the candidate advertisements will be presented to the first user, the user data representing one or more characteristics of the first user, one or more behaviors of the first user, or one or more events associated with the first user;
select a first one of the candidate advertisements for presentation to the first user; and
transmit the first candidate advertisement for presentation on the client device.

21. The system of claim 20, wherein the one or more computing devices are further configured to generate the user data for the first user with reference to one or more of: a purchase by the first user, a preference expressed by the first user, online behavior of the first user, demographic information of the first user, a location of the first user, a search by the first user, an occurrence of one of the one or more events, a context associated with the first user, or a status of the first user.

22. The system of claim 20, wherein the one or more computing devices are further configured to generate the user data by extracting information from one or more of: an electronic message sent or received by the first user, first online content posted by the first user, second online content about the first user, third online content directed to the first user, an online transaction database including one or more transactions involving the first user, or online account information of the first user.

23. The system of claim 20, wherein the one or more computing devices are configured to identify the candidate advertisements with reference to correlation data representing one or more correlations between the first user or a category of users including the first user and one or more specific advertisements or advertisement categories.

24. The system of claim 23, wherein the correlation data are associated with one or both of the first user or the candidate advertisements.
